(19) United States
(12) Patent Application Publication
(10) Pub. No.: US 2008/0009997 A1
(43) Pub. Date: Jan. 10, 2008

(54) Method for Regulating the Mixture of a Multicylinder Otto Engine Comprising Cylinder-Specific Individual Catalytic Converters and a Joint Main Catalytic Converter Mounted Down-Stream of the Individual Catalytic Converters

(76) Inventors: Alexander Ketterer, Pettendorf/Adlersberg (DE); Gerd Rosel, Regensburg (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/662,006

(22) PCT Filed: Aug. 5, 2005
(86) PCT No.: PCT/EP05/53877

§ 371 Date: Mar. 6, 2007

(30) Foreign Application Priority Data
Sep. 8, 2004 (DE) 10 2004 043 529.4

(51) Int. Cl. F02D 28/00

(52) U.S. Cl. 701/101

(57) ABSTRACT

According to one embodiment of the inventive method, half the cylinders of an in-line cylinder arrangement or the entire internal combustion engine are forcibly excited cylinder-specifically in opposite direction to the other half of the cylinders in order to balance the cylinder-specific total torque. According to another embodiment of the invention, trim regulation which compensates differences between the air quantities and/or fuel quantities introduced into the individual cylinders with the aid of the signal of a joint lambda probe is done cylinder-specifically for the individual catalytic converters. The invention also relates to lambda regulation for the joint main catalytic converter mounted downstream of the cylinder-specific individual catalytic converters.

### CROSS REFERENCE TO RELATED APPLICATIONS

This application is the US National Stage of International Application No. PCT/EP2005/053877, filed Aug. 5, 2005 and claims the benefit thereof. The International Application claims the benefits of German application No. 10 2004 043 529.4 filed Sep. 8, 2004, both of the applications are incorporated by reference herein in their entirety.

### FIELD OF INVENTION

The present invention relates to a method for regulating an air/fuel mixture of a multicylinder Otto engine having cylinder-specific individual catalytic converters and a joint main catalytic converter mounted downstream of the individual catalytic converters.

### BACKGROUND OF THE INVENTION

To purify the exhaust gas of Otto engines, a lambda-regulated 3-way catalytic converter, upstream of which a pre-catalytic converter is optionally connected close to the engine, is customarily used nowadays. A customary lambda regulation for the main catalytic converter common to all the cylinders and an optionally provided pre-catalytic converter is described, for example, in “Handbuch Verbrennungsmotor” [Internal combustion engine manual], 2^{nd} edition, Richard van Basshuysen/Fred Schäfer, pp. 559 to 561. The lambda regulation regulates the air/fuel ratio lambda (λ) with the aid of signals from a lambda probe (pre-cat probe) connected upstream of the main catalytic converter and optionally a lambda probe (post-cat probe) connected downstream of the main catalytic converter. The lambda regulation usually comprises a so-called forced excitation, which superimposes on a stochiometric lambda setpoint a periodic fluctuation in the form of a λ pulse in order to optimise the efficiency of the catalytic converter. The lambda regulation also usually comprises a so-called control or trim regulation, by means of which the signal from the pre-cat probe is corrected depending on the signal from the post-cat probe in order to offset ageing-determined measurement errors by the pre-cat probe. For further details of a conventional lambda regulation of this type comprising forced excitation and control or trim regulation, the reader is referred to the literature cited.

The previously known lambda regulation is a regulation averaged over all the cylinders, which cannot take into account cylinder-specific special features. From DE 102 06 402 C1, a method for cylinder-selective lambda regulation has already been made known, in which the signal from the lambda probe (pre-cat probe) is cyclically resolved by a microcontroller such that the lambda signal can be assigned to the individual cylinders and individual exhaust-gas packets from these cylinders thus recorded.

### SUMMARY OF INVENTION

The object of the present invention is to specify a method for regulating the mixture of a multicylinder Otto engine comprising cylinder-specific individual catalytic converters and a joint main catalytic converter mounted downstream of the individual catalytic converters, in which a cylinder-specific mixture regulation is enabled with the aid of a lambda probe common to the individual catalytic converters.

The invention and advantageous embodiments of the invention are defined in the claims.

The present invention assumes a system configuration in which an individual catalytic converter is assigned to each of the individual cylinders and a joint main catalytic converter, mounted downstream of the individual catalytic converters, is provided. The individual catalytic converters are arranged as closely as possible to the internal combustion engine and may be installed, e.g. directly mounted, in the respective elbows in order to achieve a startup of the individual catalytic converters in as short a time as possible. To record the air/fuel ratio λ, a joint lambda probe mounted downstream of the individual catalytic converters is provided.

The catalytic converters are configured respectively as 3-way catalytic converters, the individual catalytic converters having a predetermined yet relatively low oxygen storage capacity. The cylinder-specific lambda regulation comprises a cylinder-specific forced excitation by means of which a periodic fluctuation is modulated onto a mean lambda setpoint value in the form of lean-mixture and rich-mixture half-waves.

According to a first aspect of the invention, if the number of cylinders of the entire internal combustion engine or at least of a bank of cylinders is even, half of the cylinders are forcibly excited cylinder-specifically in the opposite direction to the other half of the cylinders in order to achieve a balance of the cylinder-specific torque contributions of the cylinders. Thus, for example, in a 4-cylinder engine, two cylinders are “enriched” and the other two cylinders simultaneously “enleaned”. In this way, a complete torque balance can be achieved. A further advantage of this solution is that this can be achieved in a simple manner using the method of forced excitation known in the art.

In order to maintain the converting effect of the cylinder-specific catalytic converters even where there are dynamic mixture disturbances (e.g. in stationary operating states), the oxygen loading of the individual catalytic converters produced by the forced excitation is adapted to ageing-determined changes in the oxygen storage capacity. This adaptation is possible while retaining the torque equalization.

A further advantage of this solution is that the individual catalytic converters can be operated within the range of their oxygen storage capacity; i.e. the forced excitation does not necessarily have to be driven to the extent that the individual catalytic converters reach the limit of their oxygen storage capacity in stationary operation.

According to a second aspect of the invention, a trim regulation of the mixture is provided for each of the individual catalytic converters, the air/fuel ratio downstream of the individual catalytic converters being recorded with only one joint lambda probe. Since in the given system configuration differences between the air and/or fuel masses introduced into the individual cylinders (fill differences and differences of injected fuel masses) affect the operation of the cylinder-specific individual catalytic converters, operation of the individual catalytic converters with an air/fuel ratio (λ) that is within the so-called catalytic converter window is not guaranteed. However, as is known, maximum utilization of the individual catalytic converters is possible only if all the individual catalytic converters are operated at optimum efficiency in the catalytic converter window. According to the invention, the mixture is therefore subjected to cylinder-specific trim regulation for each of the catalytic converters.

In the inventive method, cylinder-specific lambda signals are reconstructed in a cyclically resolved manner from the signal of the joint lambda probe, and a cylinder-specific trim regulation is then carried out with the aid of these reconstructed cylinder-specific lambda signals.

Here, the procedure adopted is preferably such that in advance the cylinder-specific forced excitation is adapted to the oxygen storage capacity of the individual catalytic converters such that the oxygen loading of the individual catalytic converters produced by the forced excitation reaches at the end of each lean-mixture half-wave of the forced excitation a target oxygen loading of the order of magnitude of its oxygen storage capacity, a mean reference value lying in the catalytic converter window is obtained from constant waveforms of reconstructed cylinder-specific lambda signals over all the cylinders and this mean reference value is used as a reference variable, and signal deviations of the reconstructed cylinder-specific lambda signals from the mean lambda reference value are used as a control deviation of the trim regulation.

The trim regulation provided according to the invention consequently makes use of the oxygen storage capacity of the individual catalytic converters. The constant waveforms of the cylinder-specific lambda signals are produced as a consequence of the oxygen storage of the individual catalytic converters, and to a certain extent they form the reference point for determining the cylinder-specific deviations of the air/fuel ratio.

The invention consequently enables stochiometric trimming of the mixture of each of the cylinder-specific individual catalytic converters with a single lambda probe, in order to operate all the individual catalytic converters in the catalytic converter window and thus to achieve the maximum degree of efficiency of the individual catalytic converters in a stable long-term manner.

Depending on the possible speed of reconstruction of the cylinder-specific lambda signals, the trim regulation is usefully carried out with a P-component and an I-component (high speed of signal reconstruction) or with only an I-component (low speed of signal reconstruction).

If necessary, the cylinder-specific trim regulation for the individual catalytic converters can be overlaid with the average-value trim regulation over all the cylinders, which is customarily used as standard today in order to correct age-determined measurement errors by the lambda probe.

A further advantage of the invention is that when determining the mean lambda setpoint value from constant waveforms of the cylinder-specific lambda signals over all the cylinders an offset error of the lambda probe does not affect the measurement result. An additional lambda probe for offset-error compensation is not therefore absolutely necessary, though it can of course be provided.

A third aspect of the invention relates to the lambda regulation for the main catalytic converter mounted downstream of the individual catalytic converters. In this connection, the invention provides that, when defining the parameters of the lambda regulation, configured in the usual manner, for the main catalytic converter and of an optionally provided average-value trim regulation, the oxygen storage capacity of the individual catalytic converters is taken into account. This taking into account is usefully effected by taking into account the period of time which lapses between a changeover of fuel injection caused by a rich-mixture or lean-mixture breakdown of an individual catalytic converter and the signal deviation of the relevant cylinder-specific lambda signal caused hereby.

It is also usefully provided that the lambda regulation for the main catalytic converter distinguishes between operating states with constant signal waveforms (oxygen storage not exceeded) and operating states with signal deviations of the cylinder-specific lambda signals (oxygen storage exceeded) and adapts its behaviour by correspondingly adapting the controller parameters and/or controller structure to these two operating states.

These measures enable improvement in the quality of control of the lambda regulation for the main catalytic converter by taking into account the different operating states of the lambda regulation in the form of adaptation of the controller parameters and/or structural changeovers of the regulation.

A general advantage of the aspects described of the present invention is that the joint lambda probe for the individual catalytic converters can be a binary or continuous probe and the signal of this lambda probe can be used as a reference variable for regulating the mixture of multiple cylinder-specific individual catalytic converters.

### BRIEF DESCRIPTION OF THE DRAWINGS

Further details of the invention will be explained with reference to the drawings, in which:

FIG. 1 shows a schematic diagram of a system configuration for the post-treatment of exhaust gas from a 4-cylinder internal combustion engine;

FIG. 2 shows a k pulse of a forced excitation and a reconstructed λ signal for a first cylinder of the internal combustion engine;

FIG. 3 shows a λ pulse and a reconstructed λ signal for a second cylinder;

FIG. 4 shows the signal of a joint lambda probe, taking into account the two cylinders according to FIGS. 2 and 3.

### DETAILED DESCRIPTION OF INVENTION

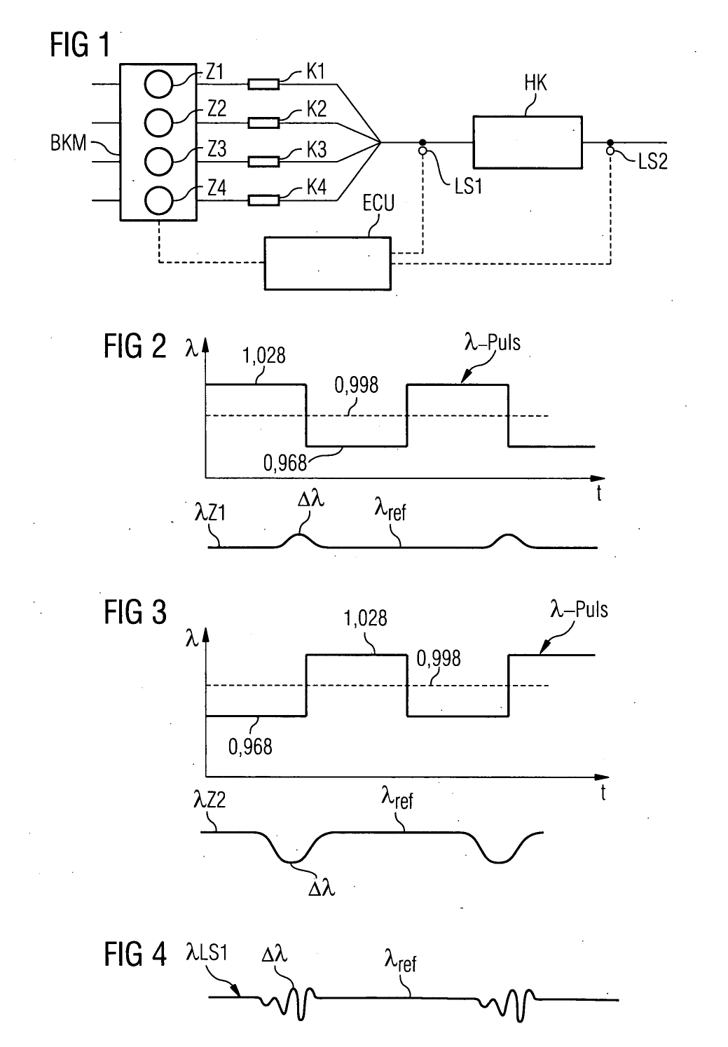

FIG. 1 shows an example of a system configuration according to the invention for a 4-cylinder Otto internal combustion engine BKM comprising four cylinders Z1-Z4, cylinder-specific individual catalytic converters K1-K4 and a main catalytic converter HK, mounted downstream of the individual catalytic converters. A lambda probe LS1, whose signal is fed to an electronic control unit ECU, is arranged between the individual catalytic converters K1-K4 and the main catalytic converter HK in the joint exhaust-gas tract. A further lambda probe LS2, whose signal is also fed to the electronic control unit ECU, is usefully connected downstream of the main catalytic converter HK. The electronic control unit performs mixture regulation in the form of a cylinder-specific lambda regulation in order to regulate the air/fuel ratio λ of cylinders Z1-Z4.

The lambda regulation comprises a cylinder-specific forced excitation in the form of a λ pulse which is modulated onto a mean lambda setpoint (0.998) and thus generates lean-mixture half-waves (λ=1.028) and rich-mixture half-waves (λ=0.968), see the above curves in FIGS. 2 and 3.

According to the first aspect of the invention, the cylinder-specific forced excitation is, as already explained in the introduction, carried out for half of the cylinders respectively in the opposite direction to that for the other half of the cylinders. Thus, for example, the rich-mixture half-waves of cylinders Z2 and Z4 are assigned to the lean-mixture half-waves of cylinders Z1 and Z3 (and vice versa), as is clear from a comparison of FIGS. 2 and 3. This enables a complete balance of the torque contributions of the cylinders, provided an even number of cylinders is provided in each bank or in each entire internal combustion engine.

Here, the same duration and amplitude of the λ pulses of the forced excitation are selected for both groups of cylinders, as can also be seen from FIGS. 2 and 3.

In order to maintain the converting effect of the cylinder-specific individual catalytic converters K1 to K4 even where there are dynamic disturbances of the mixture, the oxygen loading of the individual catalytic converters produced by the forced excitation is adapted to ageing-determined changes in the oxygen storage capacity of the individual catalytic converters (ageing adaptation).

In the given system configuration as per FIG. 1, differences in the air and/or fuel masses introduced into the individual cylinders Z1 to Z4 affect the operation of the individual catalytic converters K1 to K4 such that deviations can occur of the cylinder-specifically tuned lambda values from the optimum lambda setpoint value. These deviations may lie in the order of±3%. Without additional measures, the individual catalytic converters would then no longer be being operated at optimum efficiency in the catalytic converter window.

In order to compensate for these deviations of the cylinder-specific lambda values from the optimum lambda setpoint value, according to the second aspect of the invention a cylinder-specific trim regulation of the mixture is carried out for each of the individual catalytic converters K1 to K4. The procedure adopted here is preferably as follows:

The cylinder-specific forced excitation is adapted in advance to the oxygen storage capacity of the individual catalytic converters such that the oxygen loading of the individual catalytic converters caused by the forced excitation reaches at the end of each lean-mixture half-wave a target oxygen loading of the order of magnitude of their oxygen storage capacity. If the oxygen storage capacity of the individual catalytic converters stands for example at 10 mg, the amplitude of the forced excitation at 0.3 (λ=1.03) and a cylinder filling MAF=200 mg/stroke, then it can be calculated from this that approx. 7 lean half-waves, and thus 7 operating cycles, are required in order to achieve the target oxygen loading of the individual catalytic converter concerned under the constraints assumed. The forced excitation is therefore configured in this example such that each lean-mixture half-wave and each rich-mixture half-wave of the λ pulse extends over 7 operating cycles.

These preconditions result in a signal λLS1 from the lambda probe LS1, as shown, for example, in FIG. 4. As can be seen, the probe signal λLS1, which is shown in the example, taking only the two cylinders Z1 and Z2 into account, has a constant waveform over the greatest part of the duration of a λ pulse. This constant waveform is produced as a result of the oxygen storage of the individual catalytic converters K1 to K4. The signal from the lambda probe LS1 shown in FIG. 4 also shows signal deviations Δλ, which stem from lean-mixture breakdowns and rich-mixture breakdowns of the catalytic converters K1 and K2. The oxygen storage of K1 and K2 has to a certain extent been exceeded.

For the cylinder-specific trim regulation which is carried out by the electronic control unit ECU or else a separate controller, cylinder-specific lambda signals λZ1 and λZ2 are reconstructed in a cyclically resolved manner from the signal from the lambda probe LS1, as shown in the lower halves of FIGS. 2 and 3. The reconstructed signals λZ1 and λZ2 have constant waveforms and signal deviations Δλ, as can be seen in the lower halves of FIGS. 2 and 3.

For the trim regulation, it is necessary on the one hand to determine from constant waveforms of the reconstructed signals λZ1 and λZ2 over all the cylinders a mean reference value λref which forms the yardstick for the catalytic converter window. On the other hand, the signal deviations Δλ, shown in a bump-like manner, of the reconstructed lambda signals λZ1, λZ2, which stem from corresponding lean-mixture or rich-mixture breakdowns of the individual catalytic converters, must be interpreted as rich or lean disturbances. These signal deviations Δλ then give rise to a corresponding trim regulation response.

In the cylinder-specific trim regulation, the reference value λref determined from the constant waveforms of the reconstructed lambda signals serves as a reference variable and the signal deviations Δλ as a control deviation.

The type of controller used depends on the possible speed of reconstruction of the cylinder-specific lambda signals λZ1, λZ2. Where the speed of signal reconstruction is high, a trim controller with P- and I-components is used, whereas when the speed of signal reconstruction is low a trim controller with an I-component is used.

An advantage of the described cylinder-specific trim regulation of the mixture for the individual cylinders is that when the mean lambda reference value λref over all the cylinders is obtained any offset error of the lambda probe LS1 does not affect the measurement result. A post-cat probe like the lambda probe LS2 for offset error compensation is not therefore absolutely necessary.

As an additional measure, however, a conventional and customarily used average-value trim regulation over all the cylinders Z1 to Z4 can be superimposed on the cylinder-specific trim regulation, wherein the signal of the lambda probe LS2 connected downstream serves as a monitoring signal. This superimposed average-value trim regulation serves to stabilize exhaust gas cleaning over the service life.

In other respects, measures are provided in order to deactivate the cylinder-specific trim regulation if it is ascertained when monitoring the oxygen storage capacity of the individual catalytic converters K1-K4 that the oxygen storage capacity of one of the individual catalytic converters is less than its oxygen loading required by forced excitation. In this case, the cylinder-specific trim regulation would lead to false results since lean-mixture and rich-mixture breakdowns of the individual catalytic converters due to forced excitation cannot be separated from breakdowns due to cylinder-specific differences.

According to the third aspect of the invention, the lambda regulation provided for the main catalytic converter HK, which can for example be configured as in the bibliographical reference mentioned in the introduction “Handbuch Verbrennungsmotor” [Internal combustion engine manual], takes into account the oxygen storage capacity of the individual catalytic converters K1 to K4. As mentioned in this bibliographical reference, the lambda regulation normally uses a PII²D controller with a P-component, an I-component, an I²-component and a D-component, as well as a limitation due to non-stationary conditions. When determining a filtered lambda setpoint value, the gas runtime and the delay behaviour of the lambda probe are also taken into account. Furthermore, a mean-value trim regulation can be provided for shifting the characteristics of the signal of the lambda probe LS1 by means of the signal of the lambda probe LS2 connected downstream.

The oxygen storage capacity of the individual catalytic converters K1 to K4 can for example be taken into account by recording the period of time between a fuel injection changeover and a deviation Δλ caused hereby in the cylinder-specific lambda signal λ1 or λ2 concerned (FIGS. 2, 3). If a lean-mixture or rich-mixture breakdown of an individual catalytic converter takes place, this can be detected from the corresponding fuel injection changeover. This point in time is consequently known. In addition, the time of the change in the cylinder-specific lambda signal caused hereby can be detected. Consequently, the period which has lapsed between these two points in time can be recorded.

From this, appropriate conclusions can then be drawn for the lambda regulation. In particular, the controller parameters of the lambda controller can be adapted to the recorded period of time. The longer, for example, the corresponding time period (dead time) is, the slower, for example, the corresponding controller parameters (I-component) will be made.

It is also provided that the lambda regulation for the main catalytic converter HK distinguishes between operating states with constant signal waveforms and operating states with signal deviations of the cylinder-specific lambda signals λ1, λ2 and adapts its behaviour by correspondingly adapting the controller parameters and/or controller structure to these two operating states.

The lambda regulation thus distinguishes between the particular operating state in which oxygen is stored in the individual catalytic converters and the signal of the lambda probe LS1 is therefore extremely slow (ideally assumed as a constant waveform), and an operating state in which a lean-mixture or rich-mixture breakdown of the individual catalytic converters takes place and therefore a signal deviation of the lambda signal LS1 can immediately be detected. The lambda regulation carries out, depending on these two operating states, a case distinction, whereby, for example, it changes over the controller parameters. A different or an additional measure may be the changeover of the controller structure, whereby for example a PI-controller is made into just a P-controller and the I-component is then connected subsequently.

By means of these measures, the quality of control of the lambda regulation for the main catalytic converter HK is increased by taking into account the different operating states of the lambda regulation in the form of parameter adaptations and/or structural changeovers.

In the exemplary embodiment described, the lambda probe LS1 connected upstream is configured as a continuous probe. It can, however, also be a binary lambda probe, without modifying in any way the basic principle of the present invention.

1.-11. (canceled)

12. A method for regulating an air/fuel mixture of a multi-cylinder Otto engine, comprising:
providing a plurality of cylinder-specific individual catalytic converters configured as 3-way catalytic converters having a predetermined oxygen storage capacity, where each individual catalytic converter is assigned to a specific cylinder of the multi-cylinder engine and in flow communication with an exhaust gas stream of the multi-cylinder engine;
arranging a joint main catalytic converter downstream of the individual catalytic converters;
arranging a lambda probe common to all the individual catalytic converters between the individual catalytic converters and the main catalytic converter;
measuring a lambda signal of the lambda probe;
cyclically resolving the lambda signal to assign an to the signal to an individual cylinder multi-cylinder engine; and
forcibly exciting a cylinder specific lambda-pulse excitation wherein a periodic fluctuation is modulated onto a mean lambda setpoint in the form of lean-mixture and rich-mixture half-waves such that for an even number of cylinders of the entire internal combustion engine or of a cylinder bank, half of the cylinders are forcibly excited cylinder-specifically in the opposite direction to the other half of the cylinders in order to achieve a balance of the cylinder-specific contributions to engine torque output.

13. The method according to claim 12, wherein the same duration and amplitude of the lean-mixture and rich-mixture half-waves are selected for each of the two halves of the cylinders.

14. The method according to claim 12, wherein the oxygen loading of the individual catalytic converters produced by the forcible excitation is adapted to ageing-related changes in the oxygen storage capacity of the individual catalytic converters.

15. A method for regulating the mixture of a multicylinder Otto engine having cylinder-specific individual catalytic converters and a joint main catalytic converter mounted downstream of the individual catalytic converters, which are respectively configured as 3-way catalytic converters and have a predetermined oxygen storage capacity, and a lambda probe common to all the individual catalytic converters arranged between the individual catalytic converters and the main catalytic converter, comprising:
measuring a signal of the lambda probe;
modulating a periodic fluctuation in the form of lean-mixture and rich-mixture half-waves onto a mean lambda set-point;
cyclically reconstructing a plurality of cylinder-specific lambda signals from the signal of the lambda probe; and
performing a cylinder-specific trim regulation via the reconstructed lambda signals where a mean reference value in a catalytic converter window is obtained from constant waveforms of the reconstructed cylinder-specific lambda signals over all the cylinders,
wherein signal deviations of the reconstructed cylinder-specific lambda signals from the mean lambda reference value serve as a control deviation of the trim regulation.

16. The method according to claim 15, wherein the cylinder-specific trim regulation is performed
such that the cylinder-specific forcible excitation is adapted in advance to the oxygen storage capacity of the individual catalytic converters,
such that at the end of each lean-mixture half-wave of the forcible excitation the oxygen loading of the individual catalytic converters produced by the forcible excitation reaches a target oxygen loading of the order of magnitude of their oxygen storage capacity.

17. The method according to claim 15, wherein the cylinder-specific trim regulation is performed with a P-component and an I-component or with just an I-component depending on the speed of reconstruction of the cycle-specific lambda signals.

18. The method according to claim 15, wherein a mean-value trim regulation over all the cylinders is superimposed over the cylinder-specific trim regulation for the individual catalytic converters in order to correct ageing-determined measurement errors of the lambda probe.

19. The method according to claim 15, wherein the cylinder-specific trim regulation is deactivated if it is determined that the individual catalytic converters oxygen storage capacity is less than the oxygen loading required by the forcible excitation when monitoring the oxygen storage capacity of the individual catalytic converters.

20. The method according to claim 15, wherein a lambda regulation is provided for the main catalytic converter and, an oxygen storage capacity of the individual catalytic converters is taken into account when defining the parameters of the lambda regulation or of a mean-value trim regulation.

21. The method according to claim 20, wherein the consideration of the oxygen storage capacity of the individual catalytic converters is effected by taking into account the period of time which lapses between a fuel injection changeover caused by a rich-mixture or lean-mixture breakdown of an individual catalytic converter and a signal deviation of the relevant cylinder-specific lambda signal.

22. The method according to claim 20, wherein the lambda regulation of the main catalytic converter distinguishes between operating states with constant signal waveforms and operating states with signal deviations of the cylinder-specific lambda signals and adapts the cylinder-specific lambda signals behaviour by correspondingly adapting controller parameters and/or controller structure to operating states.
